(19) United States
(12) Patent Application Publication
(10) Pub. No.: US 2017/0197714 A1
(43) Pub. Date: Jul. 13, 2017

(54) DRONE CAPABLE OF OPERATING IN AN AQUEOUS ENVIRONMENT

(71) Applicant: Wolf-Tek, LLC, Pell City, AL (US)

(72) Inventor: John Michael Golden, Pell City, AL (US)

(21) Appl. No.: 14/994,662

(22) Filed: Jan. 13, 2016

(51) Int. Cl. B64C 39/02; B64C 25/10; B60F 5/02; B64C 25/56; B64D 47/02; B64D 47/08; B64C 37/00

(52) U.S. Cl. CPC B64C 39/024; B64D 47/08; B64C 25/10; B64C 37/00; B64C 25/56; B64D 47/02; B60F 5/02; B64C 2201/146; B64C 2201/127; B64D 2201/00

(57) ABSTRACT

Disclosed is a drone capable of operating in an aqueous environment. The drone may include a buoyant structure configured to provide buoyancy. Further, the drone may include one or more propulsion units configured to propel the drone. Furthermore, the drone may include an upper camera disposed on an upper side of the drone. Additionally, the drone may include a lower camera disposed on a lower side of the drone. Further, each of the upper camera and the lower camera may be configured to capture images. Furthermore, one or more legs configured to enable the drone to stand on a solid surface. Additionally, the drone may include one or more leg-actuators coupled to the one or more legs. Further, the one or more leg-actuators may be configured to change a state of the one or more legs to one of an extended state and a retracted state.

### FIELD OF THE INVENTION

The invention generally relates drones. More specifically, the invention relates drones capable of operating in aqueous environments.

### BACKGROUND

Drones are widely used in various applications such as reconnaissance, payload delivery, aerial photography, fire-fighting etc. Further, depending on operational requirements, drones may be designed with a variety of configurations. For instance, drones may be specially designed to possess features that enable them to withstand adverse effects of an operational environment. As an example, drones that may be required to operate under high temperatures, such as in forest fires, may be built with temperature resistant materials. Similarly, drones that may be required to operate under aqueous conditions may be designed with water-proof materials to protect water sensitive components, such as electronic circuitry in the drone.

Further, some drones may be designed to operate in different kinds of environments such as, land, air and water. For example, some drones may be equipped with landing gear that enables the drone to land on ground and carry out operations. Similarly, some drones may be equipped with buoyant structures that enable the drones to float on water. Furthermore, some hybrid drones may be capable of operating in both land and water. Such hybrid drones are also generally referred to as amphibious drones.

However, design of hybrid drones involves several challenges due to dissimilar and sometimes opposite characteristics of different environments. For instance, features implemented in a hybrid drone to enable operation in one environment may pose operational hurdles for the drone in another environment. As an example, the legs of a hybrid drone that enable landing on the ground may create drag while the hybrid drone is in flight.

Accordingly, there is a need for improved drones that are capable of efficiently operating in multiple environments.

### BRIEF OVERVIEW

This brief overview is provided to introduce a selection of concepts in a simplified form that are further described below in the Detailed Description. This brief overview is not intended to identify key features or essential features of the claimed subject matter. Nor is this brief overview intended to be used to limit the claimed subject matter's scope.

The present disclosure teaches drones that are capable of operating in aqueous environments such as swimming pool, pond, lake, sea, ocean, river and rain. Further, the drones may also be capable of operating on land and in air. In other words, the drones may be amphibious, being capable of operating in multiple environments such as air, land and water. Furthermore, the drones may be configured to efficiently operate in the multiple environments including an aqueous environments.

In order to enable the drone to operate in aqueous environments, the drone may be configured as resistant to adverse effects of an aqueous environment. For example, the drone may be constructed in such a manner that it may be impermeable to water, at depths of at least 1 m. For example, the drone may be hermetically sealed in order to prevent entry of water into the interior of the drone. As a result, water-sensitive components of the drones such as electronic circuitry, electric motor and battery may be isolated from any contact with water.

Furthermore, in order to enable the drone float on a water body, the drone may be configured to be buoyant. For instance, the drone may include a buoyant structure, such as a hollow frame, capable of naturally floating on a water body without requiring expenditure of energy in order to float. As an example, the drone may include a spherical enclosure with substantial hollow space containing a gas, such as air. As another example, propeller protectors included in the drone may also be configured to provide buoyancy to the drone. For example, the propeller protectors may be manufactured using a blow molding process resulting in hollowness.

Further, a material used to construct the drone may also afford buoyancy to the drone. As an example, a material, such as acrylic, with lower density than water, may be used to construct the drone to enable the drone to naturally float on a water body.

Alternatively, the drone may be configured to include an active floating mechanism that may use energy in order to enable the drone float on the water body. For example, the active floating mechanism may include an inflatable bladder configured to be filled with a gas, such as air. Further, a powered inflator may be included in the drone in order to compress the gas into the inflatable bladder enabling the drone to float on the water body.

Additionally, the drone may be configured to float on a water body with any one of two or more sides of the drone facing towards the water surface. In other words, the drone may be configured to float irrespective of which of the two or more sides may be facing towards the water surface. For example, the drone may include a spherical enclosure and a set of propulsion units connected to the spherical enclosure through struts so as to form a plane of symmetry separating the drone into two substantially symmetrical halves. Furthermore, the plane of symmetry may partition the drone into an upper side and a lower side. Accordingly, the drone may be configured to float with either the upper side or the lower side facing towards the water surface. The orientation of the propulsion mechanisms may be designed so to enable the drone for operation at any orientation.

Further, in order to enable the drone to stand on solid surfaces such as ground, the drone may include one or more retractable legs. A retractable leg may be configured to be set into one of an extended state and a retracted state. In the extended state, the retractable leg may be configured to make contact with the ground and support the weight of the drone in a stable manner. In the retracted state, the retractable leg may be configured to move away from the ground, such as, for example, by being pivoted. Alternatively, the retractable leg may be configured to be withdrawn into the drone or folded in order to attain the retracted state.

In some cases, the retracted state of the one or more retractable legs may be such that presence of the retractable legs may not pose substantial hindrance to an operation of the drone during flight or in aqueous environments. For example, by pivoting the retractable legs to lie in substantially the same plane as that of the drone, drag effects due to the retractable legs may be minimized as compared to when the retractable legs are in the extended state. In other words, by pivoting the retractable legs, a total surface area presented to a flow of fluid such as air or water, may be minimized. As a result, the drone may be enabled to operate in air and water more efficiently and reduced resistance.

Additionally, in order to change a state of the retractable legs between the extended state and the retracted state, the drone may include one or more leg-actuators coupled to the retractable legs. For example, a leg-actuator may be implemented using an electric motor whose shaft may be coupled to the retractable legs in such a way that activation of the electric motor may move the retractable legs from the extended state to the retracted state. Similarly, in some cases, activation of the electric motor may move the retractable legs from the retracted state to the extended state.

Further, the retractable legs may be configured to naturally remain in one of the extended state or the retracted state without requiring expenditure of energy. For example, the retractable legs may be configured to be in the extended state without application of power to the drone. However, in order to change the state of the retractable legs to the retracted state, energy may be expended, such as by activating the electric motor.

Further, the retractable legs may be configured to be set into one of the extended state and the retracted state automatically. For instance, the drone may include sensors configured to sense a context of operation and accordingly alter the state of the retractable legs. As an example, a proximity sensor included in the drone may be configured to sense the ground as the drone approaches landing and the leg-actuators may be automatically activated in order to extend the retractable legs. Similarly, the proximity sensor may detect an increasing distance from the ground during take-off and the leg-actuators may be automatically activated in order to retract the retractable legs.

Additionally, the drone may include an upper camera situated on an upper side of the drone and a lower camera situated on the lower side of the drone. Accordingly, images, such as pictures or videos, of objects lying on either side of the drone may be captured. For instance, when the drone is in flight, the upper camera may be able to capture images of the sky and the lower camera may be able to capture images of the ground. Similarly, when the drone is floating on a water body, the upper camera may be able to capture images of objects above the water surface and the lower camera may be able to capture images of objects below the water surface. Further, the upper camera and the lower camera may be configured to capture images simultaneously.

In various embodiments, the upper camera and the lower camera may be supported by gimbals in order to provide a stable orientation, such as horizontal level. Each camera may have a wide range of rotation (e.g., three hundred and sixty degree rotation ability) along the horizontal access and at least one hundred and eighty degree hemispherical rotation capability. Additionally, the upper camera and the lower camera may be mounted on a rotatable member. As a result, an orientation of the upper camera and the lower camera may be individually or synchronously controlled. Consequently, the drone may be able to perform operations such as surveillance with a greater degree of control.

Additionally, the drone may include a set of propulsion units for propelling the drone. For instance, the drone may be implemented as a quadcopter with a set of four propulsion units. Each propulsion unit may include an electric motor, a propeller blade rotatably coupled to the electric motor and a propeller protector configured to protect the propeller blade from impacts. Furthermore, the propulsion units may be configured be enable operation of the drone in aqueous environments. For instance, the electric motor and the propeller blade may be water-resistant.

Further, the drone may include a battery to power the propulsion units. The battery may be rechargeable. Furthermore, the battery may be configured to be charged in a short duration of time. Additionally, the battery may be configured to provide a flight duration of substantially long time, such as, for example, 20 minutes.

Consistent with embodiments of the present disclosure, the drone may also include a controller, such as a processor, to control operation of the drone. For instance, the controller may be configured to activate the propulsion units in order to propel the drone. Further, the controller may also be configured to control orientation of the upper camera and the lower camera. Similarly, the controller may be configured to control the leg-actuators in order to change the state of the retractable legs during landing and take-off.

The controller may be configured to steer the drone in a trajectory to follow an object. For instance, the controller may be configured to process images captured by the upper camera or the lower camera and detect an object of interest. Further, the controller may be configured to steer the drone in such a way that the object of interest remains within the field of view of either the upper camera or the lower camera.

Further, the drone may also include a positioning unit such as a GPS receiver configured to detect a position of the drone. In an auto-pilot mode, the controller may be configured to control a trajectory of the drone based on the position of the drone. For instance, a predetermined flight path may be provided to the controller in terms of position co-ordinates and the controller may periodically monitor the position of the drone to ensure that the drone follows the flight path within an acceptable level of tolerance.

Additionally, the drone may include proximity sensors to detect obstacles. Further, the controller may be configured to steer the drone away from the obstacles based on signals from the proximity sensors. As a result, the drone may be able to maneuver in congested areas while avoiding impacts with other objects. Sensors may be further configured at the sides of each propeller guards so as to, for example, detect proximity to nearby objects. In turn, this may enable the drone to better navigate obstacles that may be in its path.

A drone equipped with one or more of the foregoing features may enable the drone to operate efficiently in multiple environments including aqueous environments.

Both the foregoing brief overview and the following detailed description provide examples and are explanatory only. Accordingly, the foregoing brief overview and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the Applicant. The Applicant retains and reserves all rights in its trademarks and copyrights included herein, and grants permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure. In the drawings:

FIG. 1A illustrates a side view of a drone capable of operating in aqueous environment accordingly to various embodiments.

FIG. 1B illustrates a top view of a drone capable of operating in aqueous environment accordingly to various embodiments.

FIG. 2A illustrates a side view of a drone including a retractable leg according to various embodiments.

FIG. 2B illustrates a top view of a drone including a retractable leg according to various embodiments.

FIG. 3 illustrates a side view of a drone floating on a surface of a water body according to various embodiments.

FIG. 4 illustrates a side view of a drone including retractable legs having foot portions according to various embodiments.

FIG. 5 illustrates a cross-sectional side view of a drone including retractable legs according to various embodiments.

FIG. 6 illustrates a side view of a drone including an upper camera and a lower camera with different optical axes according to various embodiments.

FIG. 7A illustrates a side view of a drone including a spherical enclosure while the drone is standing on a solid surface according to various embodiments.

FIG. 7B illustrates a side view of a drone including a spherical enclosure while the drone is floating on water surface according to various embodiments.

FIG. 8A illustrates a side view of a drone including a movable propulsion unit while the drone is standing on the ground according to various embodiments.

FIG. 8B illustrates a side view of a drone including a movable propulsion unit while the drone is floating on a water surface according to various embodiments.

FIG. 9 illustrates a side view of a drone including a movable propulsion unit while the drone is floating on a water surface according to various embodiments.

FIG. 10 illustrates a side view of a drone configured to float under the water surface according to various embodiments.

FIG. 11 illustrates a perspective view of a drone configured to operate in aqueous environment while the drone is standing on the ground according to some embodiments.

FIG. 12 illustrates a perspective view of a drone configured to operate in aqueous environment while the drone is in flight according to some embodiments.

FIG. 13 illustrates a top view of a drone configured to operate in aqueous environment according to some embodiments.

FIG. 14 illustrates a side view of a drone configured to operate in aqueous environment while the drone is floating on water surface according to some embodiments.

FIG. 15 is a block diagram of a system including a computing device configured to control operations of a drone capable of operating in an aqueous environment according to some embodiments.

### DETAILED DESCRIPTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Regarding applicability of 35 U.S.C. §112, ¶6, no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

The present disclosure includes many aspects and features. Moreover, while many aspects and features relate to, and are described in, the context of film production, embodiments of the present disclosure are not limited to use only in this context.

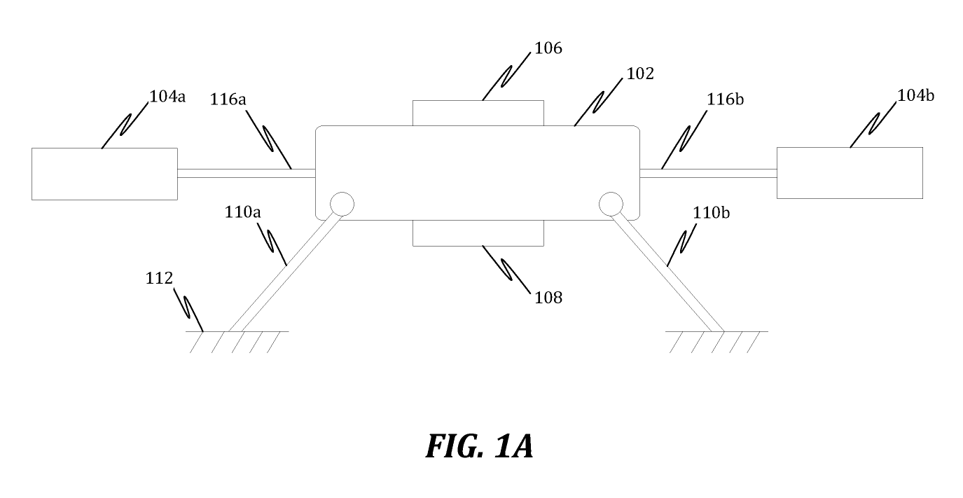

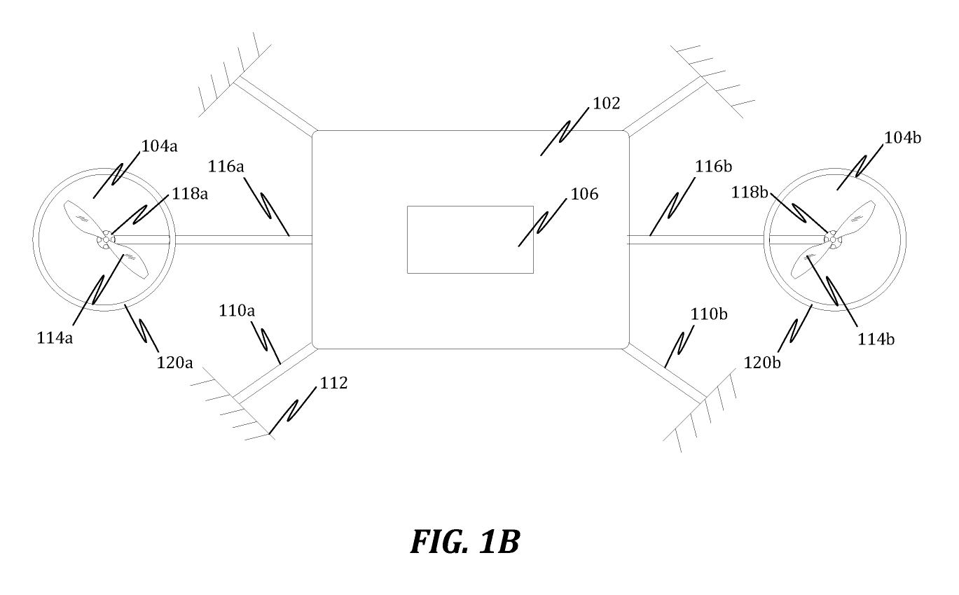

Referring to FIG. 1A and 1B, a drone 100 capable of operating in an aqueous environment according to some embodiments is illustrated. The drone 100 may include a buoyant structure 102 configured to provide buoyancy for the drone 100 in water.

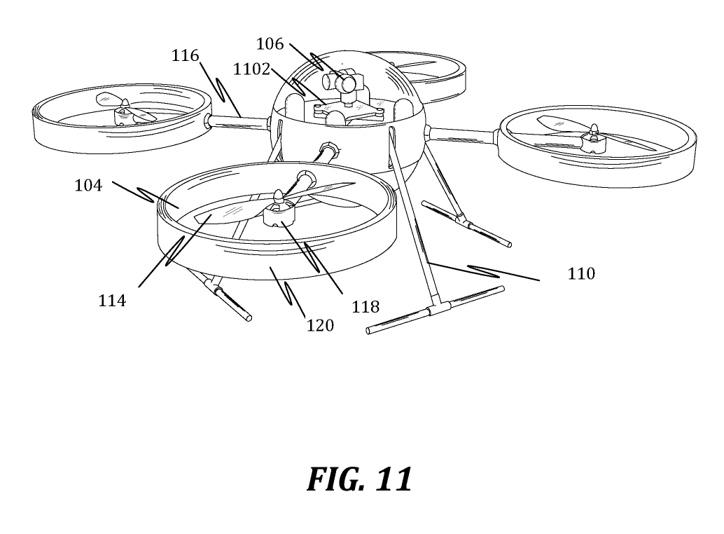

The buoyant structure 102 in general may assume a variety of forms. In some embodiments, the buoyant structure 102 may be of an aerodynamic form configured to execute a streamlined motion within a fluid such as air or water. Further, the buoyant structure 102 may be of a form that provides a substantial amount of hollow space within the buoyant structure 102. For example, the buoyant structure 102 may be in the form of a spherical enclosure, as exemplarily illustrated in FIG. 11.

Further, the buoyant structure 102 may be constructed from a material that provides buoyancy to the drone 100. For instance, the buoyant structure 102 may be constructed from a material having lower density compared to that of water. Examples of such materials may include, but are not limited to, plastics such as acrylic.

Additionally, the buoyant structure 102 may be configured to have water-resistant properties. For instance, in some embodiments, the buoyant structure 102 may be hermetically sealed. Further, in some embodiments, an outer surface of the buoyant stricture 102 may be configured to have hydrophobic properties. As a result, wetting of the outer surface of the buoyant structure 102 may be minimized. This may be advantageous in the case where one or more cameras are situated inside the buoyant structure.

Further, the drone 100 may include one or more propulsion units 104, such as 104a and 104b, configured to propel the drone. In some embodiments, the propulsion units may be powered by one or more sources of energy such as, but not limited to, electrical energy from a battery, fuel such as gasoline, solar power, wind power and electromagnetic energy such as RF waves.

Further, in some embodiments, the one or more propulsion units 104 may be configured to propel the drone 100 in one or more environments, including an aqueous environment. For example, in some embodiments, a first propulsion unit 104 may be configured to propel the drone 100 in air and a second propulsion unit 104 may be configured to propel the drone 100 while in water. Alternatively, in some embodiments, a propulsion unit 104 may be configured to propel the drone 100 in each of air, water and land. Accordingly, in some embodiments, the one or more propulsion units may include a wheel configured to support the drone 100 on a solid surface such as ground and also enable propulsion along the solid surface.

In some embodiments, the one or more propulsion units 104 may include one or more motors 118, such as 118a and 118b, and one or more propellers 114, such as propeller 114a and 114b. The one or more motors 118 may be configured to be powered by electrical energy supplied, for example, from a battery included in the drone 100. Further, the one or more motors 118 may be configured to rotate the one or more propellers 114 in one or more of clockwise direction and anti-clockwise direction. Accordingly, a direction of thrust generated by rotating the one or more propellers 114 may be controlled. Further, in some embodiments, each of the one or more motors 118 may be configured to be controlled independently. Accordingly, a speed and a direction of rotation of a first propeller 114, such as propeller 114a, may be different from a speed and a direction of rotation of a second propeller 114, such as propeller 114b. However, in some embodiments, each of the one or more motors 118 may be configured to be controlled synchronously. Accordingly, a single control signal may cause each of the one or more propellers 114 to rotate in the same direction and speed.

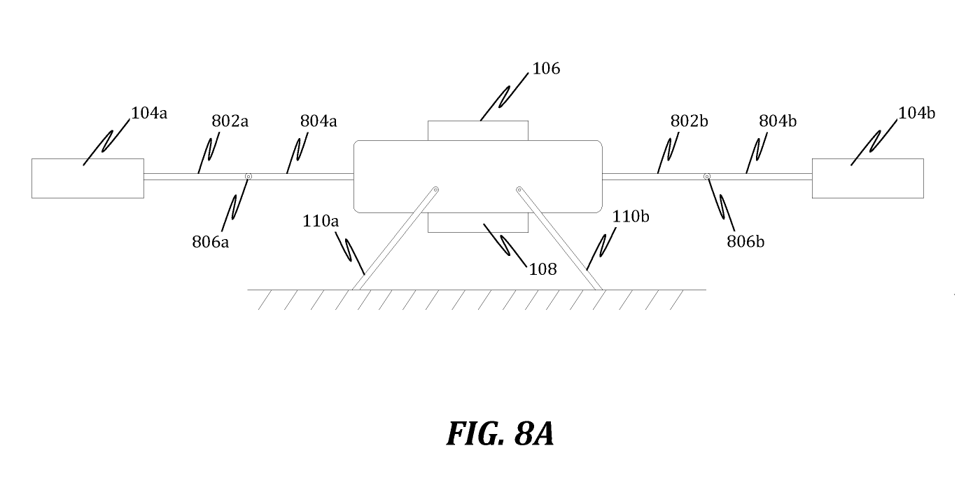

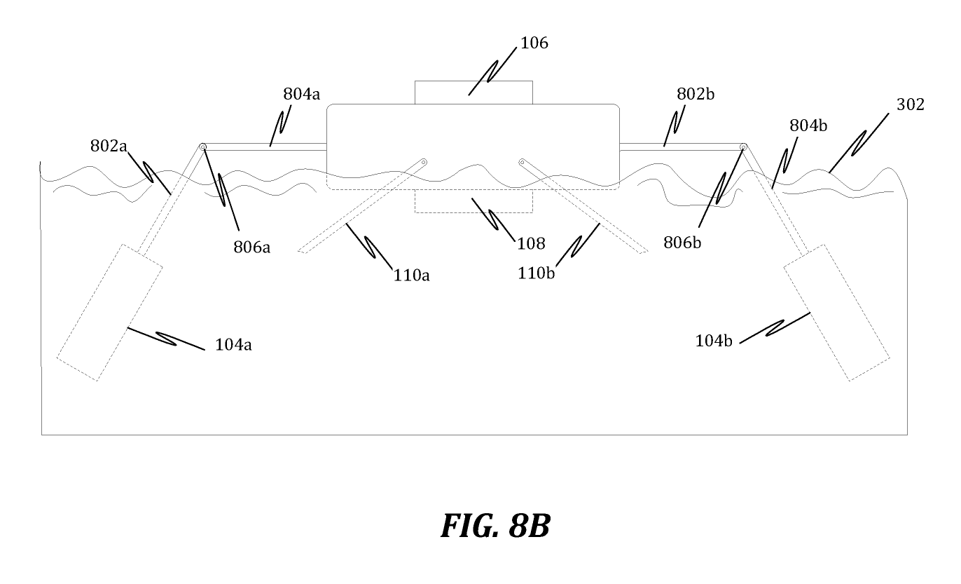

In some embodiments, the one or more propulsion units 104 may be connected to the buoyant structure 102 by one or more struts 116, such as 116a and 116b. In some embodiments, the one or more struts 116 may be configured to rigidly connect the one or more propulsion units 104 to the buoyant structure 102 as illustrated in FIG. 1A and 1B. However, in some embodiments, the one or more struts 116 may be configured to allow the one or more propulsion units 104 to be moved in relation to the buoyant structure 102. For example, as illustrated in FIG. 8A and 8B, a strut 116 may include at least one movable part to alter a position or orientation of the propulsion unit 104.

Accordingly, for instance, the strut 116a may include a movable part 802a and a fixed part 804a as illustrated in FIG. 8A. Further, the movable part 802a may be connected with the fixed part 804a at a joint 806a configured to allow the movable part 802a to move in relation to the fixed part 804a. For example, the joint 806a may be a hinge configured to allow the movable part 802a to pivotally move in relation to the fixed part 804a. Similarly, the strut 116b may include a movable part 802b and a fixed part 804b. Further, the movable part 802b may be connected with the fixed part 804b at a joint 806b configured to allow the movable part 802b to move in relation to the fixed part 804b. For example, the joint 806b may be a hinge configured to allow the movable part 802b to pivotally move in relation to the fixed part 804b.

Further, each of joint 806a and 806b may be configured to be changed from an unfolded state as illustrated in FIG. 8A to a folded state as illustrated in FIG. 8B. Further, in some embodiments, an actuator coupled to the movable part 802a and 802b may be provided to change the state of the joint between the folded state and the unfolded state. For example, when the drone 100 is operational on land and/or in air, the joints 806 may remain in the unfolded state. However, when the drone 100 is operational in a water body, as shown in FIG. 8B, the joints 806 may remain in the folded state. Accordingly, at least one propulsion unit 104 may be at least partially submerged in water. As a result, operation of the at least one propulsion unit 104 may facilitate the drone 100 to be propelled in water.

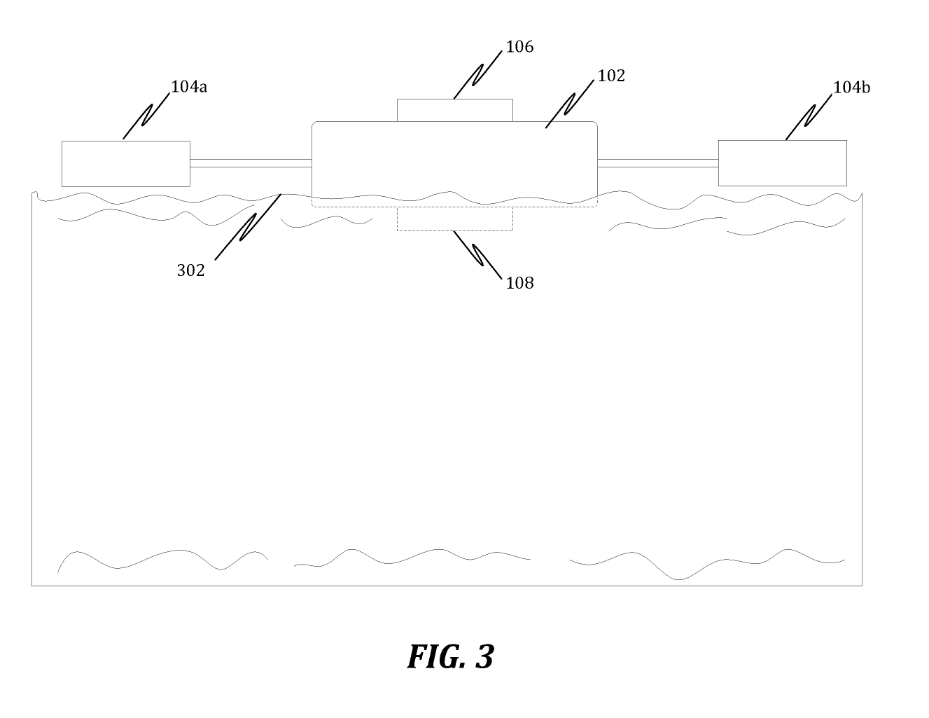

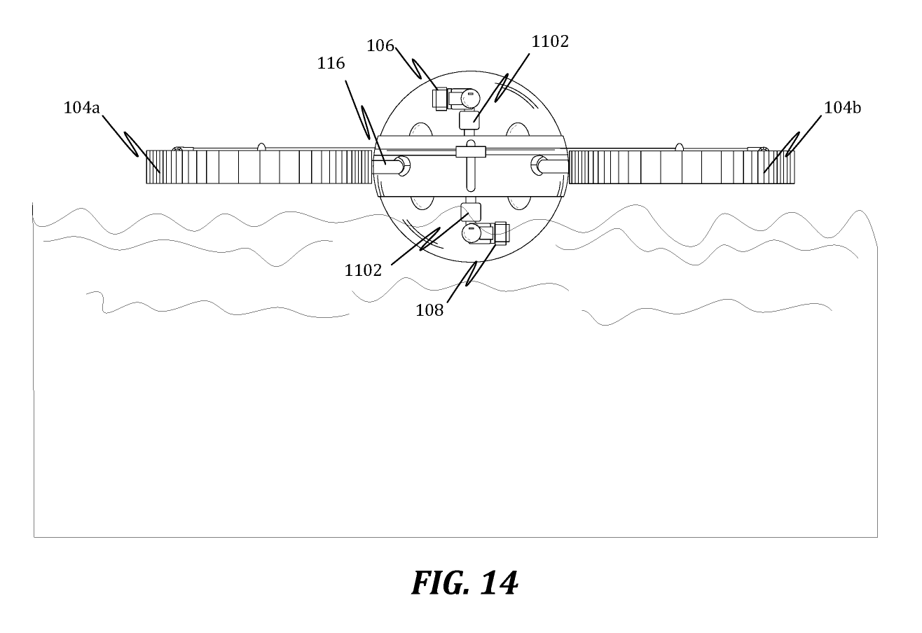

Further, in some embodiments, the one or more propulsion units 104 may be configured to enable the drone 100 to lift off from water. For instance, in some embodiments, the one or more propulsion units 104 may be connected to the buoyant structure 102 in such a way that when the drone 100 is floating on a water surface, there may be sufficient clearance space between propulsion units 104 and the water surface. For example, as exemplarily illustrated in FIG. 3 and FIG. 14, a position of the one or more propulsion units 104 in relation to the buoyant structure 102 may be such that when the drone 100 is floating on a water surface 302, a sufficient air gap exists between the lower part of the propulsion units 104 and the water surface 302. The air gap may enable sufficient air flow to take place from the upper side of the propulsion units 104 towards the lower side. As a result, sufficient thrust may be generated to lift-off the drone 100.

Further, in some embodiments, the drone 100 may be able to take-off from the water surface with substantially the same amount of energy expended as when taking-off from the ground. Alternatively, in some embodiments, the drone 100 may be so configured, that a substantially greater amount of energy may be expended in lifting off the drone 100 from a water surface as compared to lifting off the drone from the ground.

Additionally, in some embodiments, the one or more propulsion units 104 may be configured to propel the drone 100 while floating on a water body. For instance, in some embodiments, the drone 100 may include a propulsion unit 104 configured to be lowered into a water body while floating as illustrated exemplarily in FIG. 8A-8B.

As shown in FIG. 8, the strut 116 may include a movable part 802 and a fixed part 804. Further, each of the fixed part and the movable part 802 may be connected at a hinge 806. Further, an actuator may be provided to move the movable part 802. As a result, the propulsion unit 104 attached to the movable part 802 may be moved and lowered into water. Further, subsequent to lowering the propulsion units 104 into water, a direction of rotation of each propeller 114 in one of more propulsion units 104 may be changed in order to enable propulsion of the drone 100 in water. For instance, prior to being lowered into water, each propeller 114 in propulsion units 104, such as 104a and 104b may be rotating in clock-wise direction. However, subsequent to being lowered into the water body, a direction of rotation of propeller 114 in propulsion unit 104b may be reversed. As a result, each of the propulsion unit 104a and 104b may create a thrust in a same direction enabling the drone 100 to be propelled in water.

Further, in some embodiments, each component of the propulsion unit 104, such as the motor 118, the propeller 114 and the propeller protector 120 may be hermetically sealed. Accordingly, the propeller 114 may be configured to be rotated under water and create sufficient thrust to propel the drone 100 while the drone 100 is floating on the water surface.

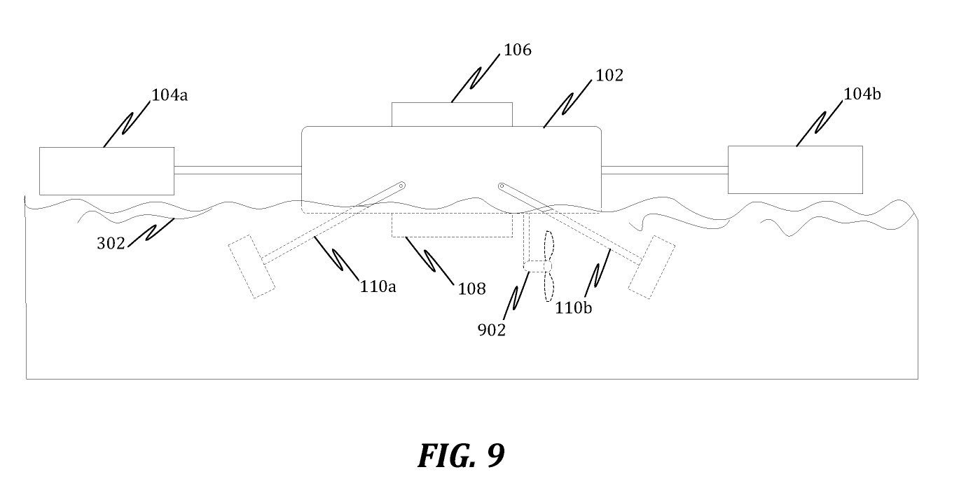

Further, in some other embodiments, the drone 100 may include a water propulsion unit, exemplarily illustrated as 902 in FIG. 9. The water propulsion unit 902 may be configured to propel the drone 100 while the drone 100 is floating on the water surface or submerged in water. Further, in some embodiments, the water propulsion unit 902 may be retractable. As a result, when the drone 100 is, for example, floating in a water body, the water propulsion unit 902 may be moved into an extended position using an actuator. Further, when the drone 100 is in flight or on land, the water propulsion unit 902 may be retracted within an enclosure of the drone 100, such as the buoyant structure 102.

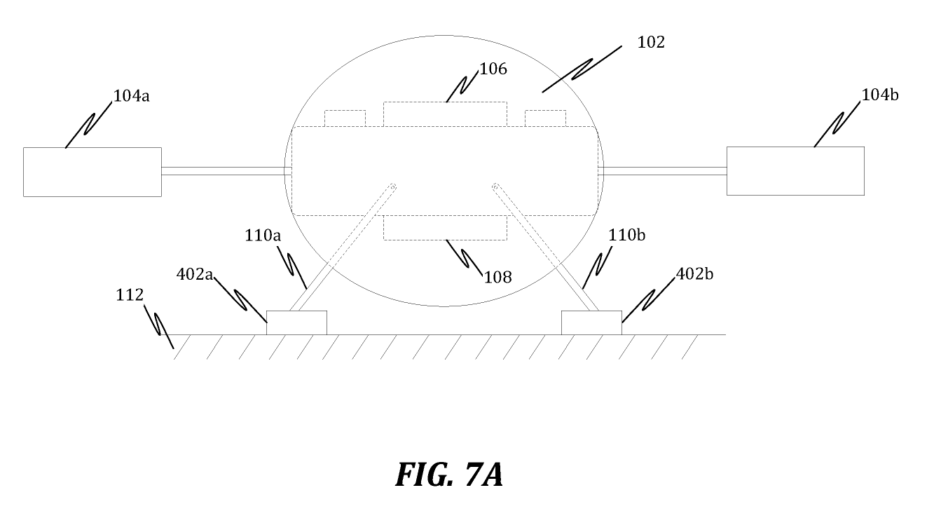

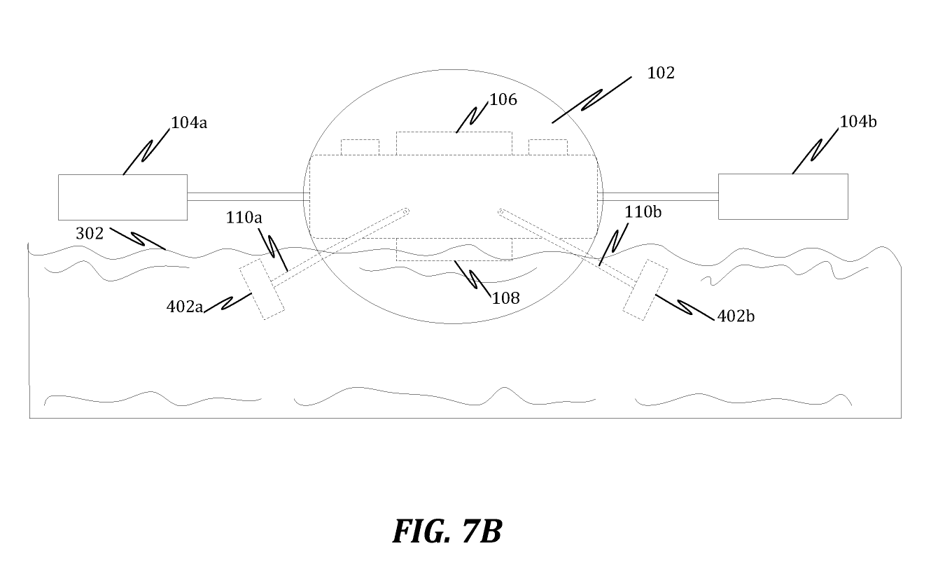

Furthermore, the drone 100 may include an upper camera 106 disposed on an upper side of the drone. The upper side of the drone 100 may be a part of the drone 100, such as, for example, an upper half of the drone 100 facing away from the ground when the drone 100 is standing on the ground. Similarly, the upper side of the drone 100 may be a part of the drone 100, such as, for example, an upper half of the drone 100 facing away from the water surface when the drone 100 is floating on water. In some embodiments, the upper side of the drone 100 may include one or more of an exterior surface of the drone 100 and an interior space of the drone 100, such as a part of the interior space of buoyant structure 102. Accordingly, in some embodiments the upper camera 106 may be disposed on the exterior surface of the drone 100 while in some other embodiments, the upper camera 106 may be disposed within the interior space of the buoyant structure 102 as exemplarily illustrated in FIG. 7A and 7B.

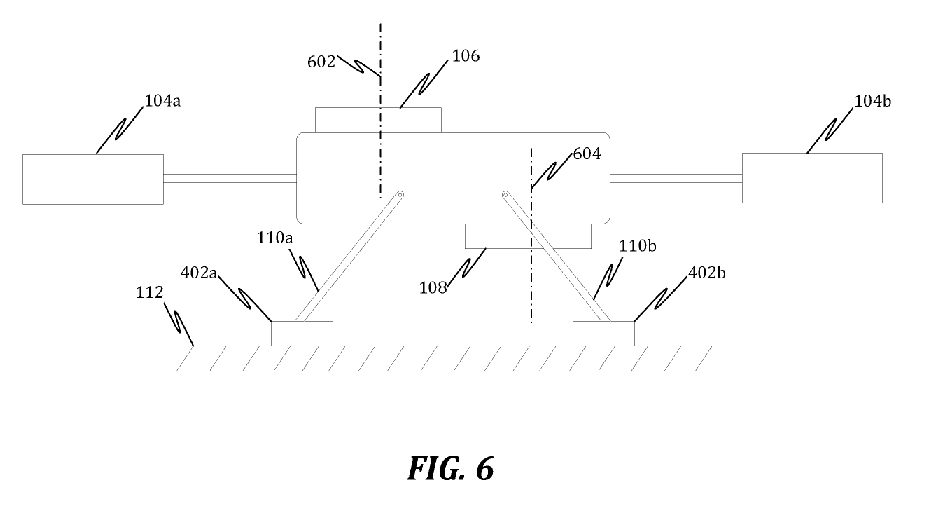

Further, a position of the upper camera 106 in relation the buoyant structure 102 may be based on operational requirements of the drone 100. For example, in some embodiments, the upper camera 106 may be located on a central region of the upper side of the drone 100 as illustrated exemplarily in FIG. 1A and 1B. Further, in some embodiments, the upper camera 106 may be located on a peripheral region of the upper side of the drone 100 as illustrated exemplarily in FIG. 6. Furthermore, in some embodiments, a position of the upper camera 106 may be movable. Accordingly, the drone 100 may include a movable support member configured to support the upper camera 106. Further, a movable support member may be configured to be actuated by an energy source to alter a position of the upper camera 106.

Additionally, the drone 100 may include a lower camera 108 disposed on a lower side of the drone 100. The lower side of the drone 100 may be a part of the drone 100, such as, for example, a lower half of the drone 100 facing towards the ground when the drone 100 is standing on the ground. Similarly, the lower side of the drone 100 may be a part of the drone 100, such as, for example, a lower half of the drone 100 facing towards the water surface when the drone 100 is floating on water. In some embodiments, the lower side of the drone 100 may include one or more of an exterior surface of the drone 100 and an interior space of the drone 100, such as a part of the interior space of buoyant structure 102. Accordingly, in some embodiments the lower camera 108 may be disposed on the exterior surface of the drone 100 while in some other embodiments, the lower camera 108 may be disposed within the interior space of the buoyant structure 102 as exemplarily illustrated in FIG. 7A and 7B.

Further, each of the upper camera 106 and the lower camera 108 may be configured to capture images. For example, each of the upper camera 106 and the lower camera 108 may include an image sensor configured to capture images based on light radiation such as, for example, visible light and infrared light. Accordingly, the drone 100 may be capable of operating in light such as during day and in low light conditions such as during night. Further, each of the upper camera 106 and the lower camera 108 may be configured to capture still images and video. Additionally, in some embodiments, one or more of the upper camera 106 and the lower camera 108 may be configured to capture panoramic images.

Furthermore, in some embodiments, each of the upper camera 106 and the lower camera 108 may be configured to capture images simultaneously. Accordingly, each of the upper camera 106 and the lower camera 108 may be configured to operate synchronously based on a common control signal.

Additionally, in some embodiments, the drone 100 may further include at least one camera-actuator configured to control one or more of a position and an orientation of one or more of the upper camera 106 and the lower camera 108. For instance, a camera-actuator may be configured to rotate the upper camera 106 in order to orient the optical axis 602 in a range of angles, such as for example, 0 to 180 degrees in relation to the ground or the water surface. As a result, one or more of the upper camera 106 and the lower camera 108 may be able to capture images from several advantageous viewpoints.

Further, in some embodiments, an optical axis 602 of the upper camera 106 may be coincident with an optical axis 604 of the lower camera 108 as exemplarily illustrated in FIG. 1. In some other embodiments, the optical axis 602 may be spaced apart from the optical axis 604 as exemplarily illustrated in FIG. 6.

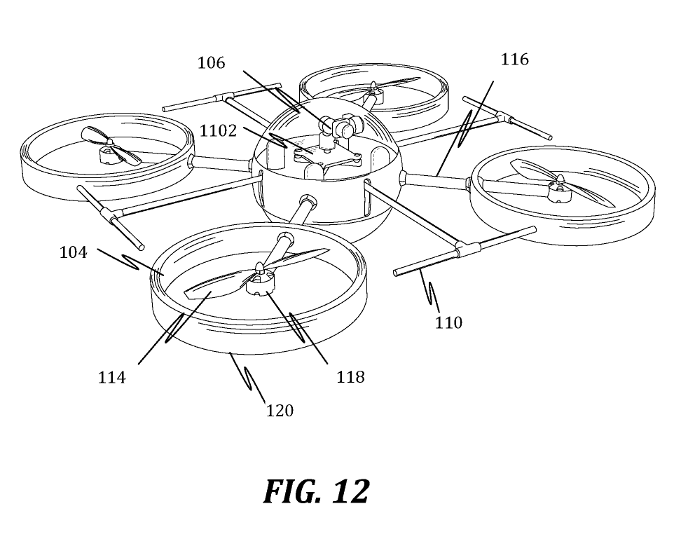

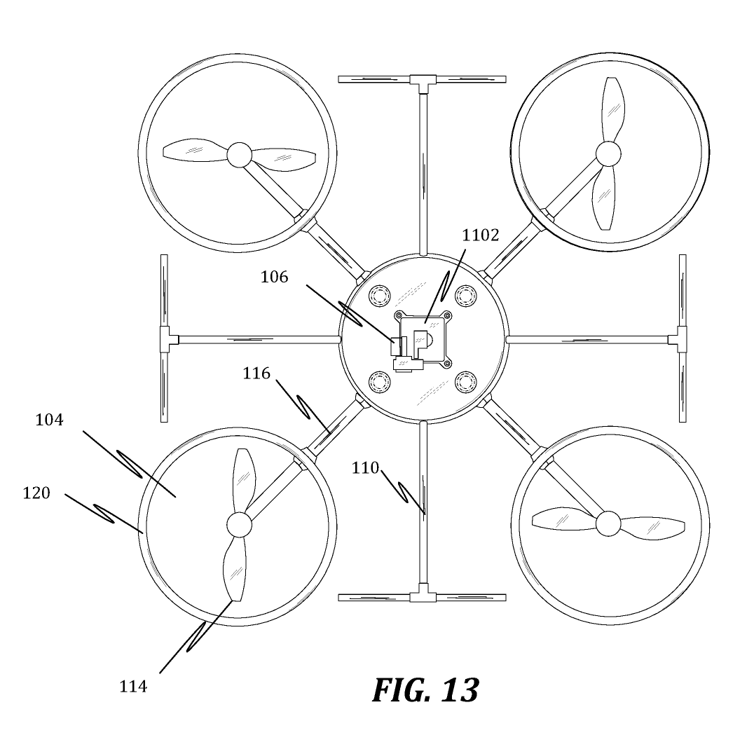

In some embodiments, the drone 100 may further include one or more gimbals, exemplarily illustrated as 1102 in FIG. 12-14. The gimbal 1102 may be configured to support one or more of the upper camera 106 and the lower camera 108. As a result, one or more of the upper camera 106 and the lower camera 108 may be maintained in a stable level, such as a horizontal level, in spite of changes in orientation of the drone 100. As a result, images captured by one or more of the upper camera 106 and the lower camera 108 may not be distorted due to movement of the drone 100 such as vibrations or changes in orientation of the drone 100.

In some embodiments, the buoyant structure 102 may include a spherical enclosure configured to enclose each of the upper camera 106 and the lower camera 108 as exemplarily illustrated in FIG. 7A and 7B.

Further, in some embodiments, the buoyant structure 102 may include a propeller protector 120, such as 120a and 120b as illustrated in FIG. 1B. The propeller protector 120 may be configured to protect the propellers 114 from contacting with external objects. Additionally, in some embodiments, the propeller protectors 120 may be configured to be buoyant. For instance, the propeller protectors 120 may be constructed from acrylic using a blow molding process. As a result, the propeller protectors 120 may be hollow with sufficient interior space to provide, at least partially, buoyancy to the drone 100.

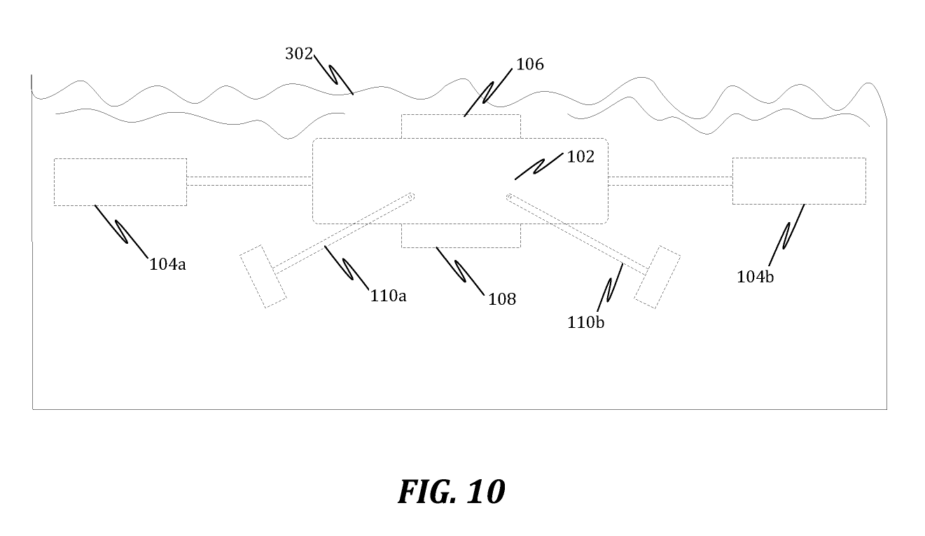

Additionally, in some embodiments, the buoyant structure 102 may include an inflatable bladder. Also, the drone 100 may further include an inflator configured to inflate the inflatable bladder. Furthermore, the drone 100 may be configured to sink in water based on an inflation state of the inflatable bladder as exemplarily illustrated in FIG. 10. For example, the drone 100 may be configured such that reducing the amount of air within the inflatable bladder may cause the drone 100 to sink in water. As a result, by controlling the inflation state of the inflatable bladder, the drone 100 may be positioned below the water surface.

Furthermore, in some embodiments, the buoyant structure 102 may include a ballast tank configured to allow water from the water body into the buoyant structure 102 causing the drone 100 to sink. Further, the ballast tank may also be configured to pump out the water from the buoyant structure 102 in order to enable the drone 100 to rise towards the surface of the water body. As a result, by controlling the water level in the ballast tank, the drone 100 may be positioned below the water surface at any depth.

Furthermore, the drone 100 may include one or more legs 110 configured to enable the drone 100 to stand on a solid surface 112, such as the ground. Each leg 110 may include a first end configured to be connected to a part of the drone 100, such as the buoyant structure 102. Further, each leg 110 may include a second end configured to come in contact with the solid surface 112. Additionally, the one or more legs 110 may be sufficiently rigid in order to stably support the weight of the drone 100 while landed on the solid surface 112.

Additionally, the drone 100 may include one or more leg-actuators 202 coupled to the one or more legs 110. Further, the one or more leg-actuators 202 may be configured to change a state of the one or more legs 110 to one of an extended state and a retracted state.

In the extended state, the legs 110 may be configured to make contact with the solid surface 112 and support the weight of the drone 100 in a stable manner. In the retracted state, the legs 110 may be configured to move away from the solid surface 112, such as, for example, by being pivoted. For example, as illustrated in FIG. 11, while the drone 100 is standing on the ground, the legs 110 may be in the extended state. Further, as illustrated in FIG. 12, while the drone 100 is in flight or floating on a water body, the legs 110 may be in the retracted state.

Alternatively, in some embodiments, the legs 110 may be configured to be withdrawn into the drone 100 or folded in order to attain the retracted state. For example, the legs 110 may be telescopic structures with a fixed end attached to a part of the drone 100 while a movable end is configured to come in contact with the solid surface 112. Further, a length of the telescopic structures may be controlled by activating the leg-actuators. Accordingly, in some embodiments, the legs 110 may be completely withdrawn into an interior space of the drone 100 such as the buoyant structure 102 as exemplarily illustrated in FIG. 3.

In some embodiments, one of the extended state and the retracted state may be a natural state of the legs 110. Further, no energy may be expended in order to maintain the legs 100 in the natural state. However, in some embodiments, in order to change and maintain a state other than the natural state, energy may be expended.

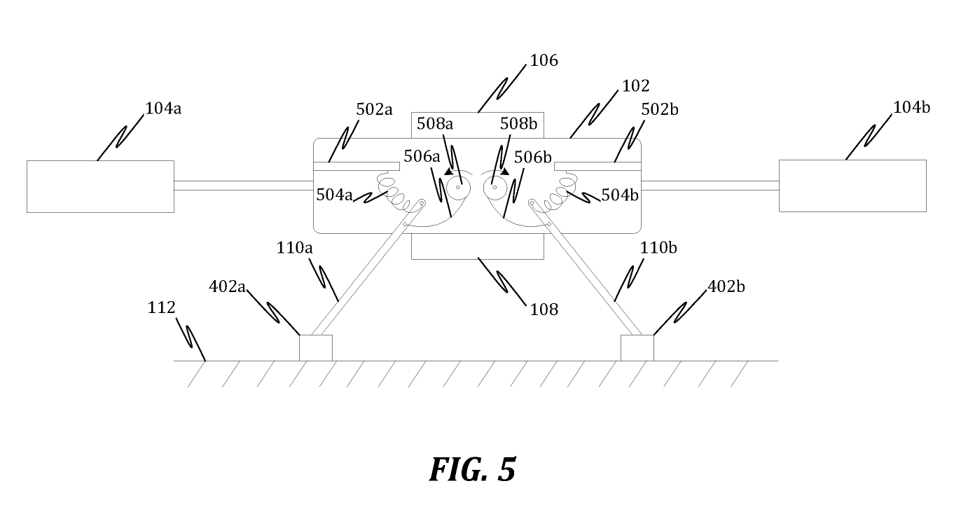

For example, as exemplarily illustrated in FIG. 5, the legs 110 may be configured to be in the retracted state as a natural state. As a result, no energy may be used during a time when the drone 100 is in flight or in water. Further, each leg 110 may be attached to a spring mechanism configured to maintain the leg 110 in the retracted state. For example, as illustrated, the drone 100 may include a spring support member 502 and a spring 504. Further, one end of spring 504 may be attached to the spring support member 502 while the other end of spring 504 may be attached to a part of the leg 110. As a result, the spring 504 may tend to resist movement of the leg 110 away from the retracted state and also tend to return the leg 110 to the retracted state. Further, the drone 100 may include a motor 508 and a cable 506 in order to change the state of the leg 110 to the extended state. One end of the cable 506 may be attached to a shaft of the motor while the other end of the cable 506 may be attached to a part of the leg 110. Further, activation of the motor 508 may cause the cable 506 to be wound around the shaft while pulling the leg 110 into the extended state. Accordingly, the drone 100 may be enabled to land on the ground.

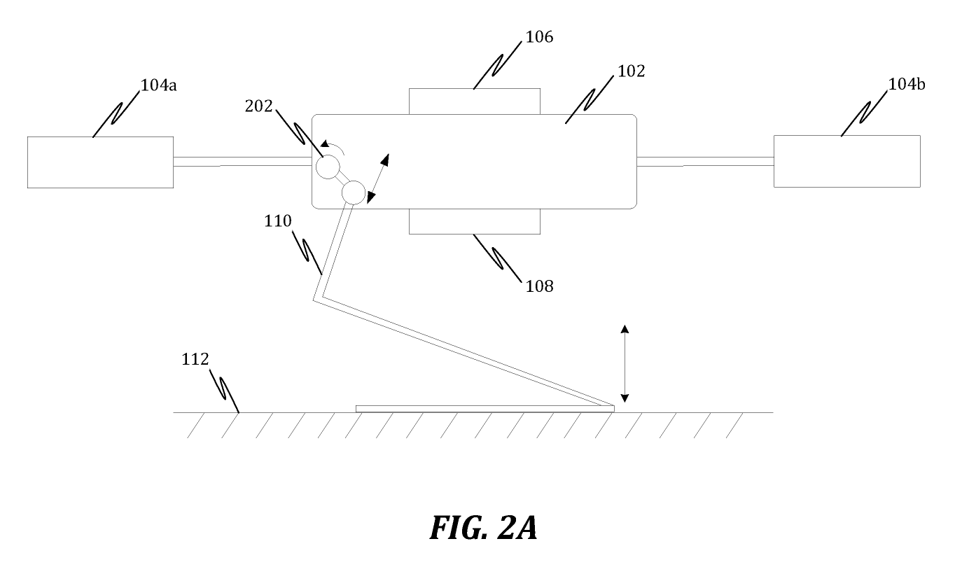

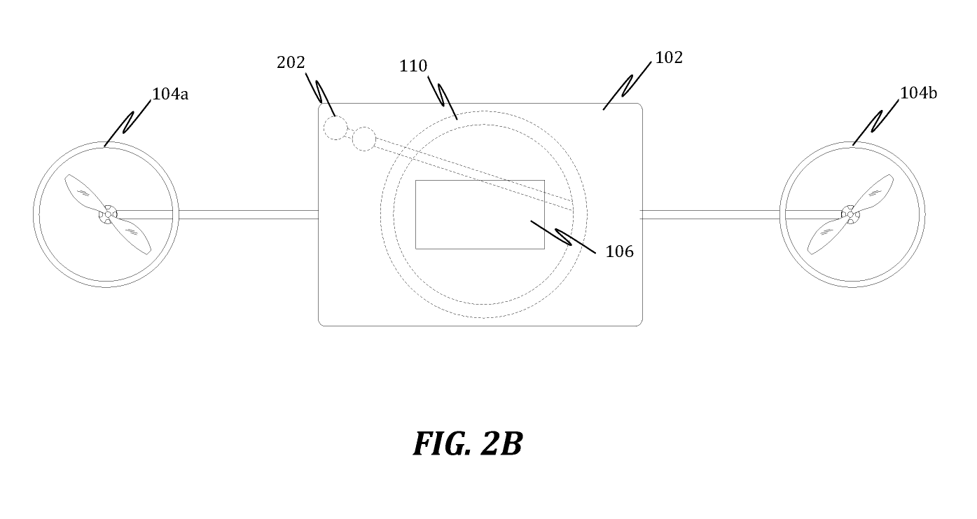

In some embodiments, the drone 100 may include a single leg 110 as shown exemplarily in FIG. 2A and 2B. A first end of the leg 110 may be coupled to the leg-actuator 202 while a second end of the leg 110 may be configured to distribute the weight of the drone 100 at multiple points of contact with the solid surface 112. For example, as shown in FIG. 2B, the second end of the leg 110 may be in the form of a circular rod configured to come in contact with the solid surface 112. Further, in some embodiments, the leg 110 may be configured such that in the retracted state, the circular rod may be drawn close to the lower side of the drone 100. As a result, presence of the leg 110 while in the retracted state may not present any hindrances to operation of the drone 100 in air or water.

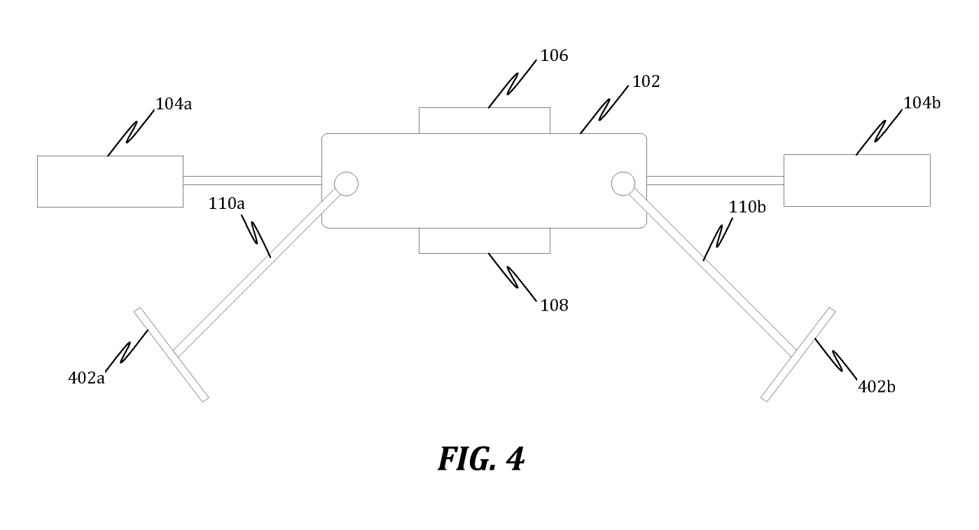

In some embodiments, the one or more legs 110 may include a plurality of legs 110, such as, for example, four legs as illustrated in FIG. 1B. Further, each leg 110 may include an extension portion and a foot portion exemplarily illustrated as 402 in FIG. 4. Additionally, a first end of the extension portion may be connected to at least a portion of the drone 100, such as for example, the buoyant structure 102. Furthermore, a second end of the extension portion may be connected to the foot portion 402. Further, the foot portion 402 may be configured to rest on the solid surface 112.

Further, in some embodiments, the drone 100 may be configured to float on a water body with one of the upper side and the lower side facing towards the surface of the water body. In other words, the drone 100 may possess operational symmetry, with respect to floating, along a plane dividing the drone 100 into the upper side and the lower side. As a result, landing of the drone 100 over a water body may be performed without regard to which side of the drone 100 is facing towards the surface of the water body.

Additionally, in some embodiments, the one or more legs 110 may be configured to enable the drone 100 to stand on the solid surface 112 with one of the upper side and the lower side facing towards the solid surface 112. In other words, the drone 100 may possess operational symmetry, with respect to standing on the ground, along a plane dividing the drone 100 into the upper side and the lower side.

For example, each leg 110 of the drone 100 as illustrated in FIG. 11 may be configured to be pivoted between a first position and a second position at a pivotal point. Further, while being in the first position, the leg 110 may be configured to support the weight of the drone 100 with the lower side of the drone 100 facing the ground. Similarly, while being in the second position, the leg 110 may be configured to support the weight of the drone 100 with the upper side of the drone 100 facing the ground. Accordingly, in some embodiments, an angle executed by the leg 110 in moving from the first position to the second position may be twice the angle between the leg 110 and a plane of symmetry of the drone 100 passing through the pivotal point. As a result, landing of the drone 100 on the ground may be performed without regard to which side of the drone 100 is facing towards the ground.

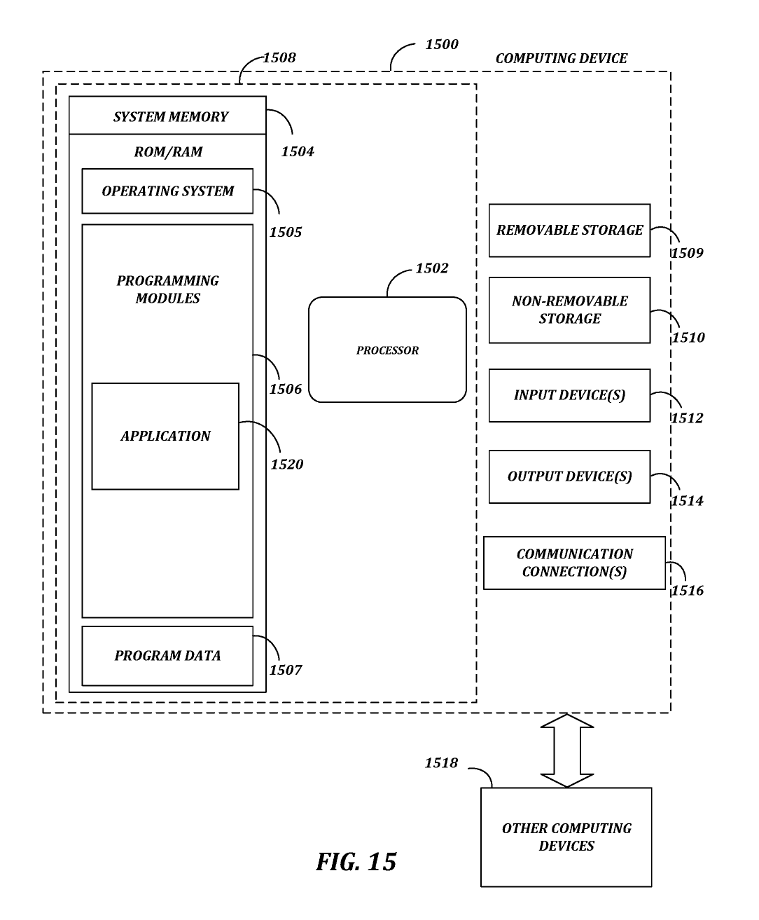

In some embodiments, the drone 100 may further include a radio transceiver configured to communicate data over radio waves. Further, the drone 100 may also include a processor configured to control one or more of the one or more propulsion units 104, the upper camera 106, the lower camera 108, the one or more leg-actuators 202 and the radio transceiver. Further, the processor may be communicatively coupled with a memory storage. In some embodiments, the processor and the memory storage may be implemented in the form of a computing device, such as, for example, computing device 1500 as illustrated in FIG. 15.

In some embodiments, the drone 100 may further include an enclosure configured to enclose each of the upper camera 106, the lower camera 108, the one or more leg-actuators 202, the radio transceiver and the processor. Further, the enclosure may be hermetically sealed.

In some embodiments, the drone 100 may further include one or more proximity sensors. Further, the processor may be configured to control the one or more propulsion units 104 based on an output of the one or more proximity sensors. As a result, collision of the drone 100 with external objects may be avoided. Additionally, in some embodiments, the drone 100 may further include a Global Positioning System (GPS) receiver.

In some embodiments, the drone 100 may further include a wireless controller configured to control operation of the drone 100. Further, the wireless controller may include an input device configured to receive a control input. Additionally, the wireless controller may include a radio transceiver configured to communicate data over radio waves. Further, the data may include each of the control input and images captured by one or more of the upper camera 106 and the lower camera 108.

Furthermore, the wireless controller may include a display device configured to display images captured by one or more of the upper camera 106 and the lower camera 108. Accordingly, a user operating the wireless controller may be able to view the images and control the orientation or position of one or more of the upper camera 106 and the lower camera 108 in order to obtain images as per the user's needs. Further, in some embodiments, the display device may be configured to provide a split screen view showing an image from the upper camera 106 on one portion of the display screen while showing an image from the lower camera 108 on another portion of the display screen.

Additionally, in some embodiments, the drone 100 may further include a controller enclosure configured to enclose the wireless controller. Additionally, the controller enclosure may be hermetically sealed. As a result, the wireless controller may be submerged under water while still being operational. Accordingly, a user submerged under water may be enabled to control the drone 100 floating on the water surface. For example, the user may create a selfie-video using the drone 100 while being submerged under water.

Additionally, in some embodiments, the processor may be further configured to perform image processing of images captured by one or more of the upper camera 106 and the lower camera 108. Further, the processor may be configured to control one or more of the one or more propulsion units 104, the upper camera 106, the lower camera 108, the one or more leg-actuators 202 and the radio transceiver based on a result of the image processing.

In some embodiments, the image processing may include detection of one or more of a solid body and a water body. Further, the processor may be further configured to control the one or more leg-actuators 202 based on the detection. For example, while the drone 100 is approaching the ground, one or more of the upper camera 106 and the lower camera 108 facing towards the ground may capture images of the ground. Subsequently, based on analysis of successive images, the processor may be configured to automatically determine that the drone 100 is approaching the ground. Further, a time at which the drone 100 may be likely to land on the ground may also be predicted based on a rate of descent and a distance from the ground. In some embodiments, the distance from the ground may be determined based on a ranging sensor included in the drone 100. Alternatively, in some other embodiments, the distance may be determined based on an altimeter included in the drone 100. Accordingly, the processor may activate the leg-actuators 202 in order to change the state of the legs 110 to the extended state in preparation to landing.

In some embodiments, the processor may be further configured to perform image correction on images captured by one or more of the upper camera 106 and the lower camera 108 facing towards a water body. Further, image correction may compensate for a water based distortion in the images. The water based distortion may be caused by optical properties of the water body. As a result, images obtained by the drone 100 while floating on the water surface or while being submerged in a water body may be improved.

In some embodiments, the drone 100 may further include one or more water sensors disposed on one or more of the upper side and the lower side of the drone 100. Additionally, the drone 100 may include an upper light source disposed on the upper side of the drone 100. Further, the drone 100 may include a lower light source disposed on the lower side of the drone 100. Furthermore, one or more of the upper light source and the lower light source may be configured to be activated based on an output of the at least one water sensor. As a result, illumination may be provided into the water body in order to improve quality of images of objects lying within the water body. Further, since one or more of the upper light source and the lower source may be selectively activated, energy from a source, such as a battery included in the drone 100 may be used efficiently.

Further disclosed is drone 100 capable of operating in aqueous environment, such as illustrated in FIG. 11-14. The drone 100 may include a spherical body 102 configured to provide buoyancy in water. Further, the spherical body 102 may be hermetically sealed. Additionally, the drone 100 may include a battery configured to provide electrical energy. Further, the drone 100 may include a plurality of propulsion units 104 configured to propel the drone 100. Furthermore, each propulsion unit 104 may include an electric motor 118 and a propeller 114. Additionally, each propulsion unit 104 may be connected to the spherical body 102 by a strut 116. Further, the drone 100 may include a plurality of propeller protectors 120 corresponding to the plurality of propulsion units 104. Additionally, each propeller protector 120 may be connected to a corresponding strut 116. Further, each propeller protector 120 may be configured to protect a corresponding propeller 114. Additionally, the drone 100 may include one or more upper cameras 106 disposed in an upper hemisphere of the spherical body 102. Further, the drone 100 may include one or more lower cameras 108 disposed in a lower hemisphere of the spherical body 102. Additionally, the drone 100 may include a plurality of legs 110 configured to enable the drone 100 to stand on a solid surface 112. Further, the drone 100 may include one or more leg-actuators 202 coupled to the plurality of legs 110. Additionally, the one or more leg-actuators 202 may be configured to change a state of the plurality of legs 110 to one of an extended state and a retracted state. Further, the drone 100 may include a radio transceiver configured to communicate data over radio waves. Furthermore, the data may include one or more of control input generated by a wireless controller and images captured by one or more of the upper camera 106 and the lower camera 108. Additionally, the drone 100 may include a processor configured to control one or more of the plurality of propellers, the one or more upper cameras 106, the one or more lower cameras 108, the one or more leg-actuators 202 and the radio transceiver.

FIG. 15 is a block diagram of a system including computing device 1500 configured to control one or more operations of the drone 100 according to some embodiments. Consistent with various embodiments of the disclosure, the aforementioned memory storage and processor may be implemented in a computing device, such as computing device 1500 of FIG. 15. Any suitable combination of hardware, software, or firmware may be used to implement the memory storage and processor. For example, the memory storage and processor may be implemented with computing device 1500 or any of other computing devices 1518, in combination with computing device 1500. The aforementioned system, device, and processors are examples and other systems, devices, and processors may comprise the aforementioned memory storage and processor, consistent with embodiments of the disclosure.

With reference to FIG. 15, a system consistent with various embodiments of the disclosure may include a computing device, such as computing device 1500. In a basic configuration, computing device 1500 may include at least one processor 1502 and a system memory 1504. Depending on the configuration and type of computing device, system memory 1504 may comprise, but is not limited to, volatile (e.g. random access memory (RAM)), non-volatile (e.g. read-only memory (ROM)), flash memory, or any combination. System memory 1504 may include operating system 1505, one or more programming modules 1506, and may include a program data 1507. Operating system 1505, for example, may be suitable for controlling computing device 1500′s operation. In one embodiment, programming modules 1506 may include a drone control application 1520. Furthermore, embodiments of the disclosure may be practiced in conjunction with a graphics library, other operating systems, or any other application program and is not limited to any particular application or system. This basic configuration is illustrated in FIG. 15 by those components within a dashed line 1508.

Computing device 1500 may have additional features or functionality. For example, computing device 1500 may also include additional data storage devices (removable and/or non-removable) such as, for example, magnetic disks, optical disks, or tape. Such additional storage is illustrated in FIG. 15 by a removable storage 1509 and a non-removable storage 1510. Computer storage media may include volatile and nonvolatile, removable and non-removable media implemented in any method or technology for storage of information, such as computer readable instructions, data structures, program modules, or other data. System memory 1504, removable storage 1509, and non-removable storage 1510 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 1500. Any such computer storage media may be part of device 1500. Computing device 1500 may also have input device(s) 1512 such as a keyboard, a mouse, a pen, a sound input device, a touch input device, etc. Output device(s) 1514 such as a display, speakers, a printer, etc. may also be included. The aforementioned devices are examples and others may be used.

Computing device 1500 may also contain a communication connection 1516 that may allow device 1500 to communicate with other computing devices 1518, such as over a network in a distributed computing environment, for example, an intranet or the Internet. Communication connection 1516 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 1504, including operating system 1505. While executing on processor 1502, programming modules 1506 (e.g., drone control application 1520) may perform processes including, for example, one or more operations of drone 100 as described above. The aforementioned process is an example, and processor 1502 may perform other processes. Other programming modules that may be used in accordance with embodiments of the present disclosure may include electronic mail and contacts applications, word processing applications, spreadsheet applications, database applications, slide presentation applications, drawing or computer-aided application programs, etc.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, multiprocessor systems, microprocessor-based or programmable consumer electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

All rights including copyrights in the code included herein are vested in and the property of the Applicant. The Applicant retains and reserves all rights in the code included herein, and grants permission to reproduce the material only in connection with reproduction of the granted patent and for no other purpose.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

Insofar as the description above and the accompanying drawing disclose any additional subject matter that is not within the scope of the claims below, the disclosures are not dedicated to the public and the right to file one or more applications to claims such additional disclosures is reserved.

The folowing is claimed:

1. A drone capable of operating in an aqueous environment, the drone comprising:
a buoyant structure configured to provide buoyancy for the drone in water;
at least one propulsion unit configured to propel the drone;
an upper camera configured to capture images, wherein the upper camera is disposed on an upper side of the drone;
a lower camera configured to capture images, wherein the lower camera is disposed on a lower side of the drone;
at least one leg configured to enable the drone to stand on a solid surface; and
at least one leg-actuator coupled to the at least one leg, wherein the at least one leg-actuator is configured to change a state of the at least one leg to one of an extended state and a retracted state.

2. The drone of claim 1, wherein an optical axis of the upper camera is coincident with an optical axis of the lower camera.

3. The drone of claim 1, wherein each of the upper camera and the lower camera is configured to capture images simultaneously.

4. The drone of claim 1, wherein the buoyant structure comprises a spherical enclosure configured to enclose each of the upper camera and the lower camera.

5. The drone of claim 1, wherein the buoyant structure comprises a propeller protector.

6. The drone of claim 4, wherein the at least one leg comprises a plurality of legs, wherein each leg comprises an extension portion and a foot portion, wherein a first end of the extension portion is connected to at least a portion of the spherical enclosure, and wherein a second end of the extension portion is connected to the foot portion.

7. The drone of claim 1, further comprising:
a transceiver configured to communicate data; and
a processor configured to control at least one of the following: the at least one propulsion unit, the upper camera, the lower camera, the at least one leg-actuator, the transceiver, and a buoyancy of the buoyant structure.

8. The drone of claim 1, further comprising an enclosure configured to enclose each of the upper camera, the lower camera, a transceiver, and a processor, wherein the enclosure is hermetically sealed.

9. The drone of claim 7, further comprising at least one proximity sensor, wherein the processor is configured to control the at least one propulsion unit based on an output of the at least one proximity sensor.

10. The drone of claim 1, further comprising at least one gimbal configured to support at least one of the upper camera and the lower camera.

11. The drone of claim 1, wherein the at least one propulsion unit comprises at least one motor and at least one propeller.

12. The drone of claim 1, further comprising a Global Positioning System (GPS) receiver.

13. The drone of claim 1, further comprising a wireless controller configured to control operation of the drone, the wireless controller comprising:
an input device configured to receive a control input;
a transceiver configured to communicate data, wherein the data comprises each of the control input and images captured by at least one of the upper camera and the lower camera; and
a display device configured to display images captured by at least one of the upper camera and the lower camera.

14. The drone of claim 1, wherein the at least one propulsion unit is configured to enable the drone to lift off from water.

15. The drone of claim 1, further comprising at least one camera-actuator configured to control at least one of a position and an orientation of at least one of the upper camera and the lower camera.

16. The drone of claim 7, wherein the processor is further configured to:
perform image processing of images captured by at least one of the upper camera and the lower camera; and
control at least one of the at least one propulsion unit, the upper camera, the lower camera, the at least one leg-actuator and the transceiver based on a result of the image processing.

17. The drone of claim 1, wherein the drone is configured to float on a water body with one of the upper side and the lower side facing towards the surface of the water body.

18. The drone of claim 1, wherein the at least one leg is configured to enable the drone to stand on the solid surface with one of the upper side and the lower side facing towards the solid surface.

19. A drone capable of operating in aqueous environment, the drone comprising:
An approximately spherical body configured to provide buoyancy in water, wherein the spherical body is hermetically sealed;
a plurality of propulsion units configured to propel the drone, wherein each propulsion unit comprises an electric motor and a propeller, wherein each propulsion unit is connected to the spherical body by a strut;
a plurality of propeller protectors corresponding to the plurality of propulsion units, wherein each propeller protector is connected to the corresponding strut, wherein each propeller protector is configured to protect the corresponding propeller;
at least one upper camera disposed in an upper hemisphere of the spherical body;
at least one lower camera disposed in a lower hemisphere of the spherical body;
a communications module configured to communicate data; and
a processor configured to control at least one of the plurality of propellers, the at least one upper camera, the at least one lower camera, and the communications module.

20. The drone of claim 19, further comprising a plurality of legs configured to enable the drone to stand on a solid surface.

21. The drone of claim 20, further comprising at least one leg-actuator coupled to the plurality of legs, wherein the at least one leg-actuator is configured to change a state of the plurality of legs to one of an extended state and a retracted state.

22. The drone of claim 21, wherein the data comprises at least one of control input generated by a wireless controller and images captured by at least one of the upper camera and the lower camera.

23. The drone of claim 19, wherein the at least one propulsion unit is configured to propel the drone while floating on a water body.

24. The drone of claim 19, wherein the buoyant structure comprises an inflatable bladder, wherein the drone further comprises an inflator configured to inflate the inflatable bladder.

25. The drone of claim 16, wherein the image processing comprises detection of at least one of a solid body and a water body, wherein the processor is further configured to control the at least one leg-actuator based on the detection.

26. The drone of claim 25, wherein the processor is further configured to perform image correction on images captured by at least one of the upper camera and the lower camera facing towards a water body, wherein image correction compensates for a water based distortion in the images, wherein the water based distortion is caused by optical properties of the water body.

27. The drone of claim 19, further comprising a controller enclosure configured to enclose a wireless controller, wherein the controller enclosure is hermetically sealed.

28. The drone of claim 19, further comprising:
at least one water sensor disposed on at least one of the upper side and the lower side of the drone;
an upper light source disposed on the upper side of the drone; and
a lower light source disposed on the lower side of the drone, wherein at least one of the upper light source and the lower light source is configured to be activated based on an output of the at least one water sensor.
